(19) United States
(12) Patent Application Publication
(10) Pub. No.: US 2008/0122729 A1
(43) Pub. Date: May 29, 2008

(54) ANTENNA ARRANGEMENT

(75) Inventor: MICHAEL PHILIPPAKIS, Coombe (GB)

Correspondence Address: PAUL, HASTINGS, JANOFSKY & WALKER LLP, 875 15th Street, NW, Washington, DC, 20005, US

(73) Assignee: ITI Scotland Limited, Glasgow (GB)

(21) Appl. No.: 11/773,233

(22) Filed: Jul. 3, 2007

(30) Foreign Application Priority Data
Jul. 7, 2006 (GB) 0613610.5

(51) Int. Cl. H01Q 3/24

(52) U.S. Cl. 343/876

(57) ABSTRACT

An antenna arrangement for use in an ultra-wideband network comprises a plurality of active monopoles. Each monopole is oriented substantially perpendicular to a ground plane, and arranged in a row along a transmission axis. Each monopole has an active portion for emitting radio signals and switch means for selectively changing the length of the active portion. Control means are provided for controlling the plurality of switch means such that, in a first configuration, the lengths of the active portion of the monopoles increase from a first end of the row towards the opposite end of the row, thereby causing radio signals to be emitted by the antenna arrangement substantially in a first direction along the transmission axis from the opposite end of the row towards the first end of the row. In a second configuration, the lengths of the active portion of the monopoles increase from the opposite end of the row towards the first end of the row, thereby causing radio signals to be emitted by the antenna arrangement substantially along the transmission axis in a direction opposite to the first direction.

### TECHNICAL FIELD OF THE INVENTION

The invention relates to an antenna arrangement for a communication system, and in particular relates to an antenna arrangement for use in an ultra wideband (UWB) wireless communication system.

### BACKGROUND TO THE INVENTION

Ultra-wideband is a radio technology that transmits digital data across a very wide frequency range, 3.1 to 10.6 GHz. It makes use of ultra low transmission power, typically less than −14 dBm/MHz, so that the technology can literally hide under other transmission frequencies such as existing Wi-Fi, GSM and Bluetooth. This means that ultra-wideband can co-exist with other radio frequency technologies. However, this has the limitation of limiting communication to distances of typically 5 to 20 metres.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 20 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into five band groups, four having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

The antenna arrangements used in ultra-wideband systems are usually omni-directional, meaning that radio signals are emitted in all directions from an active radiating element, or elements. However, it is also desirable to use antenna arrangements which emit radio signals in a particular direction or directions.

Fixed beam directional antennas, such as a log periodic antennas, are known and an exemplary antenna arrangement is shown in FIG. 2. The log periodic antenna 2 comprises a ground plane 4 and a plurality of elements 6a, 6b, 6c, 6d, 6e and 6f connected to an input signal line 8. The elements 6a-6f have different lengths and are arranged in size order on the ground plane 4 with the shortest element 6a at one end and the longest element 6f at the other end. The distance between each of the elements 6a-6f increases logarithmically from the end of the antenna 2 with element 6a to the end of the antenna 2 with element 6f. The input signal line 8 is located towards the shortest element 6a, so that the elements 6a-6f are supplied in series with a signal. The increased length that the input signal has to travel to a subsequent element 6a-6f in comparison to the previous element 6a-6f, results in the elements 6a-6f emitting signals that are slightly out of phase with each other. The arrangement of the elements 6a-6f results in the antenna 2 emitting signals in the direction indicated by arrow 10.

By directing the emitted radio signals in a particular direction or directions, interference with other nearby communication links can be reduced, thereby allowing the capacity of the communication system (in terms of the number of possible communication links) to be increased.

However, although this log periodic antenna emits radio signals in a particular direction relative to the ground plane, this direction is fixed and cannot be adjusted.

It is therefore an aim of the invention to provide a directional antenna arrangement for use in an ultra-wideband system that allows some degree of control in the direction of the emitted signal.

### SUMMARY OF THE INVENTION

There is therefore provided an antenna arrangement for use in an ultra-wideband network, the antenna arrangement comprising a plurality of elements, each element having an active portion for emitting radio signals and switch means for selectively changing the length of the active portion of the element; means for controlling the plurality of switch means such that there is a variation in the lengths of the active portions across the antenna arrangement; wherein the variation in the lengths of the active portions causes the emitted radio signals to be emitted from the antenna arrangement in a particular direction.

Preferably, each of the elements is a monopole.

Preferably, each monopole is oriented substantially perpendicular to a ground plane.

Preferably, the elements are arranged in a row along a transmission axis.

In a preferred embodiment, the means for controlling the plurality of switch means is adapted to control the switch means into a first configuration in which the lengths of the active portion of the elements increase from a first end of the row towards the opposite end of the row, thereby causing radio signals to be emitted by the antenna arrangement substantially in a first direction along the transmission axis from the opposite end of the row towards the first end of the row, and into a second configuration in which the lengths of the active portion of the elements increase from the opposite end of the row towards the first end of the row, thereby causing radio signals to be emitted by the antenna arrangement substantially along the transmission axis in a direction opposite to the first direction.

In a further preferred embodiment, the arrangement further comprises means for providing an excitation signal to each of the plurality of elements, such that, when the switch means are in the first configuration, the excitation signal is supplied in series from the element at the first end of the row towards the element at the opposite end of the row, and when the switch means are in the second configuration, the excitation signal is supplied in series from the element at the opposite end of the row towards the element at the first end of the row.

Preferably, in either the first or the second configuration, the lengths of the active portion of the elements increase substantially linearly from one end of the row towards the other end of the row.

According to a second aspect of the invention, there is provided a communication device for use in an ultra wideband network, the device comprising an antenna arrangement as described above.

### BRIEF DESCRIPTION OF THE DRAWINGS

For a better understanding of the present invention, and to show more clearly how it may be carried into effect, reference will now be made, by way of example only, to the following drawings in which:

FIG. 1 shows the multi-band OFDM alliance (MBOA) approved frequency spectrum of a MB-OFDM system;

FIG. 2 shows a conventional directional antenna arrangement;

FIG. 3 shows an antenna arrangement in accordance with the invention; and

FIG. 4 shows an alternative antenna arrangement in accordance with the invention.

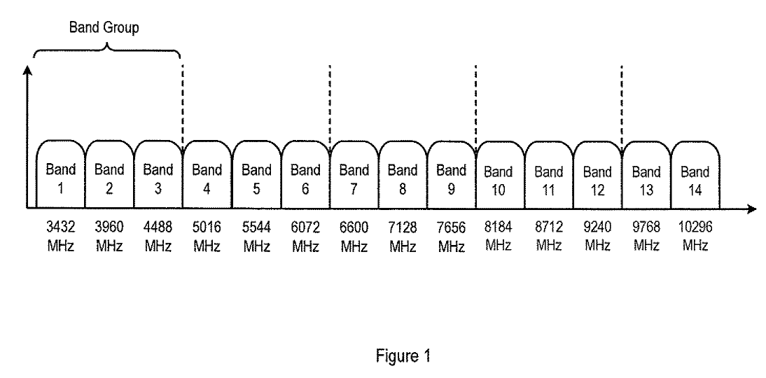

### DETAILED DESCRIPTION OF THE PREFERRED EMBODIMENTS

Although the invention will be described further herein as relating to use in an ultra wideband network, it will be appreciated that the invention can be adapted for use in other types of network.

FIG. 3 shows an antenna arrangement 20 comprising a ground plane 22 and a plurality of radiating elements 24, individually denoted 24a, 24b, 24c, 24d, 24e and 24f. Although six elements are shown in the antenna arrangement of FIG. 3, it will be appreciated that any number of elements greater than one can be used in accordance with the invention.

In this embodiment, the elements 24 are in the form of monopoles oriented substantially perpendicular to the ground plane 22. The elements 24 are arranged in a row or line along the ground plane 22, with this row or line being denoted the transmission axis. In alternative embodiments of the invention, the elements may be arranged in an array. In a preferred embodiment, the elements 24 are evenly spread along the transmission axis. In other words, the spacing between each of the elements 24 is the same. In an alternative embodiment, the elements 24 are not spread evenly along the transmission axis, but the separation distance between the elements 24 is symmetrical around the centre of the antenna arrangement 20. That is, in this illustrated embodiment, the distance between elements 24a and 24b will be the same as the distance between elements 24e and 24f. Likewise, the distance between elements 24b and 24c will be the same as the distance between elements 24d and 24e.

Each of the elements 24 is connected to an input signal line 26 which provides the signal for the elements 24 to radiate.

Each element 24 includes at least one switch 28 located along its length for changing the effective length of the active radiating portion of the element 24. The switches 28 effectively divide each element 24 into sections, and serve to selectively connect or isolate these sections from the signal on input signal line 26. The switches 28 may be realised using semiconductor switches or variable reactive devices, or other suitable switches known to those skilled in the art.

In the illustrated embodiment, each element 24 includes a respective switch 28 (28a, 28b, 28c, 28d, 28e and 28f), which divides each element 24 into two sections, a lower section 30 (30a, 30b, 30c, 30d, 30e and 30f) and an upper section 32 (31a, 31b, 32c, 32d, 32e and 32f). When switches 28a, 28b, 28c, 28d, 28e and 28f are open, the length of the active portion of the elements 24 (i.e. the length of the section of the element 24 in electrical contact with the input signal line 26) corresponds to the length of the lower sections 30a, 30b, 30c, 30d, 30e and 30f respectively. When switches 28a, 28b, 28c, 28d, 28e and 28f are closed, the length of the active portion of each element 24 is increased, and corresponds to the combined length of the respective upper and lower sections 30a and 32a, 30b and 32b, 30c and 32c, 30d and 32d, 30e and 32e, 30f and 32f.

In alternative embodiments of the invention, each element 24 may include a number of switches 28 along its length, thereby increasing the number of possible variations in the length of the active portion.

In order to control the operation of the switches 28, control means are provided for controlling the operation of the antenna arrangement 20. The control means is not shown in FIG. 3, but may take the form of a processor that is connected to each of the switches 28, and which outputs a signal to cause a respective switch 28 to change from an “open” state to a “closed” state, and vice versa.

The control means operates the switches between a number of configurations in which there is a variation in the lengths of the active portions across the antenna arrangement, which allows the direction that radio signals are emitted by the individual elements 24 to be controlled.

It can be seen from FIG. 3 that the lengths of the upper and lower sections 32 and 30 of the elements 24 are not equal to each other, and that the switches 28 are also located at different positions along the elements 24. This is to allow the radio signals emitted by each element 24 to be shaped into a beam, so that the radio signals are emitted in a particular direction.

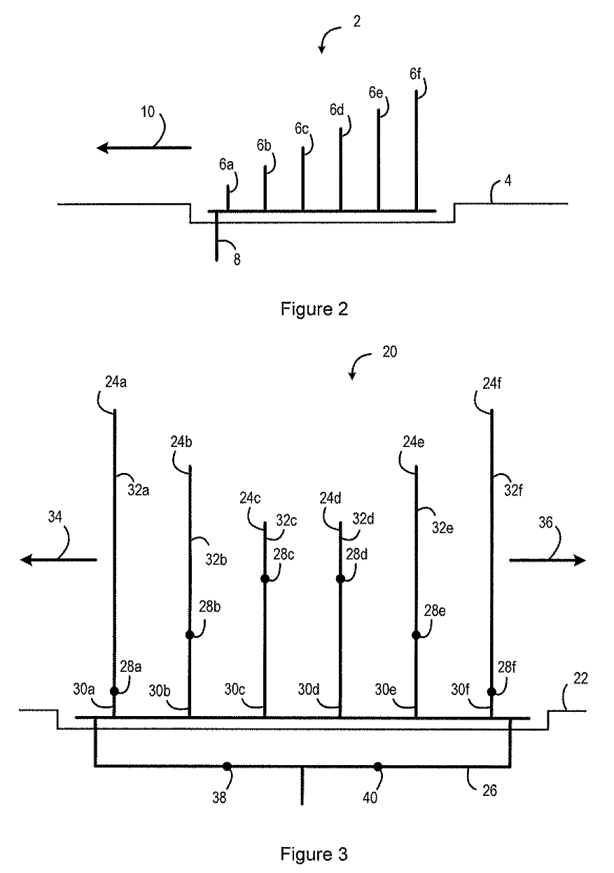

For example, from FIG. 3, it can be seen that, when switches 28a, 28b and 28c are open, and switches 28d, 28e and 28f are closed, the profile of the antenna arrangement 20 created by the length of the active portions of elements 24a, 24b, 24c, 24d, 24e and 24f corresponds to the profile of the log periodic antenna arrangement 2 in FIG. 2 created by the length of the elements 6a, 6b, 6c, 6d, 6e and 6f. Thus, when the switches 28 are in this configuration, radio signals from the elements 24 are emitted substantially along the transmission axis in the direction indicated by arrow 34.

When the antenna arrangement 20 is changed to a second configuration in which switches 28a, 28b and 28c are closed, and switches 28d, 28e and 28f are open, the profile of the antenna arrangement 20 created by the length of the active portions of elements 24a, 24b, 24c, 24d, 24e and 24f corresponds to the opposite profile of the log periodic antenna arrangement 2 in FIG. 2 created by the length of the elements 6a, 6b, 6c, 6d, 6e and 6f. Thus, when the switches 28 are in this configuration, radio signals from the elements 24 are emitted substantially along the transmission axis in the direction indicated by arrow 36, which is the opposite direction to that indicated by arrow 34.

Thus, it can be seen from this illustrated embodiment that the variation in the lengths of the active portions across the antenna arrangement 20 corresponds to an approximately linear increase in the lengths of the active portion of the elements 24 along the line. It will be appreciated, however, that other configurations are possible depending on the nature of the desired beam.

In this illustrated embodiment, the elements 24 are connected to the input signal line 26 in series, which means that one element 24 in the line receives the input signal before the next element 24 in the line.

In order for the signals emitted by the elements 24 in the antenna arrangement 20 to be in phase with each other, it is necessary to change the order in which the elements 24 are provided with the input signal when the antenna arrangement 20 is switched between the two configurations. Thus, first and second switches 38 and 40 are provided in the input signal line 26.

As described above, in the first configuration, where switches 28a, 28b and 28c are open and switches 28d, 28e and 28f are closed, the radio signals are emitted in the direction indicated by arrow 34. In the configuration, switch 38 is closed and switch 40 is opened, which causes the elements 24 to be provided with the input signal in series from element 24a to element 24f. Thus, the signals emitted by the individual elements 24 in the direction indicated by arrow 34 will be in phase with each other.

In the second configuration, where switches 28a, 28b and 28c are closed and switches 28d, 28e and 28f are open, the radio signals are emitted in the direction indicated by arrow 36. In this configuration, switch 38 is opened and switch 40 is closed, which causes the elements 24 to be provided with the input signal in series from element 24f to element 24a. Thus, the signals emitted by the individual elements 24 in the direction indicated by arrow 36 will be in phase with each other.

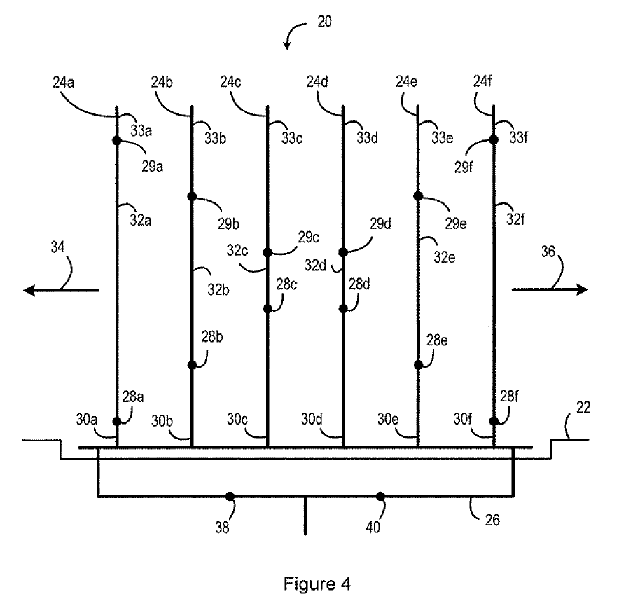

FIG. 4 shows an alternative antenna arrangement 20 in accordance with the invention. In this Figure, the antenna arrangement 20 is as described with reference to FIG. 3, and like reference numerals are used for like features in the Figures. However, in this arrangement 20, each of the radiating elements 24a-f are the same length. Furthermore, each element 24 is provided with two switches 28, 29 along its length for changing the effective length of the radiating portion of the element 24. The switches 28, 29 effectively divide each element 24 into three sections, and again serve to selectively connect or isolate these sections from the signal on input signal line 26.

As shown, each element 24 includes a respective lower switch 28 (28a, 28b, 28c, 28d, 28e and 28f) and an upper switch 29 (29a, 29b, 29c, 29d, 29e and 29f). Thus, each element is divided into a lower section 30 (30a, 30b, 30c, 30d, 30e and 30f), an intermediate section 32 (32a, 32b, 32c, 32d, 32e and 32f) and an upper section 33 (33a, 33b, 33c, 33d, 33e and 33f).

When switches 28a, 28b, 28c, 28d, 28e and 28f are open, the length of the active portion of the elements 24 (i.e. the length of the section of the element 24 in electrical contact with the input signal line 26) corresponds to the length of the lower sections 30a, 30b, 30c, 30d, 30e and 30f respectively. When switches 28a, 28b, 28c, 28d, 28e and 28f are closed, the length of the active portion of each element 24 is increased, and corresponds to the combined length of the respective intermediate and lower sections 30a and 32a, 30b and 32b, 30c and 32c, 30d and 32d, 30e and 32e, 30f and 32f.

In FIG. 4, it can be seen that, when switches 28a, 28b, 28c, 29d, 29e and 29f are open, and switches 28d, 28e and 28f are closed, the profile of the antenna arrangement 20 created by the length of the active portions of elements 24a, 24b, 24c, 24d, 24e and 24f corresponds to the profile of the log periodic antenna arrangement 2 in FIG. 2 created by the length of the elements 6a, 6b, 6c, 6d, 6e and 6f. Thus, when the switches 28 and 29 are in this configuration, radio signals from the elements 24 are emitted substantially along the transmission axis in the direction indicated by arrow 34. As switches 28a, 28b and 28c are open in this configuration, it does not matter whether switches 29a, 29b and 29c are open or closed.

When the antenna arrangement 20 is changed to a second configuration in which switches 28a, 28b and 28c are closed, and switches 29a, 29b, 29c, 28d, 28e and 28f are open, the profile of the antenna arrangement 20 created by the length of the active portions of elements 24a, 24b, 24c, 24d, 24e and 24f corresponds to the opposite profile of the log periodic antenna arrangement 2 in FIG. 2 created by the length of the elements 6a, 6b, 6c, 6d, 6e and 6f. Thus, when the switches 28 and 29 are in this configuration, radio signals from the elements 24 are emitted substantially along the transmission axis in the direction indicated by arrow 36, which is the opposite direction to that indicated by arrow 34. As switches 28d, 28e and 28f are open in this configuration, it does not matter whether switches 29d, 29e and 29f are open or closed.

The operation of the switches 38 and 40, which provide the phase difference between the radiating elements 24, is as described above with reference to FIG. 3.

A third configuration mode can be provided in this antenna arrangement 20. Specifically, all switches 28, 29 can be closed, which means that the active length of each of the radiating elements 24 will be the same across the arrangement 20.

There is therefore provided a directional antenna arrangement for use in an ultra-wideband system that allows the direction that signals are emitted to be adjusted. The preferred embodiment describes how the antenna can be arranged to fire a beam in a first or second direction depending on the configuration of the switches 28 in the elements 24. It will be appreciated, that other configurations are possible, including the directing of a beam in more than two directions, or the directing of two or more beams at different relative angles to those shown, depending on the arrangements of the elements 24 and the switches 28.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. An antenna arrangement for use in an ultra-wideband network, the antenna arrangement comprising:
a plurality of elements, each element having an active portion for emitting radio signals and switch means for selectively changing the length of the active portion of the element;
means for controlling the plurality of switch means such that there is a variation in the lengths of the active portions across the antenna arrangement; wherein the variation in the lengths of the active portions causes the emitted radio signals to be emitted from the antenna arrangement in a particular direction.

2. An antenna arrangement as claimed in claim 1, wherein each of the elements is a monopole.

3. An antenna arrangement as claimed in claim 2, wherein each monopole is oriented substantially perpendicular to a ground plane.

4. An antenna arrangement as claimed in claim 1, wherein the elements are arranged in a row along a transmission axis.

5. An antenna arrangement as claimed in claim 4, wherein the means for controlling the plurality of switch means is adapted to control the switch means into a first configuration in which the lengths of the active portion of the elements increase from a first end of the row towards the opposite end of the row, thereby causing radio signals to be emitted by the antenna arrangement substantially in a first direction along the transmission axis from the opposite end of the row towards the first end of the row, and into a second configuration in which the lengths of the active portion of the elements increase from the opposite end of the row towards the first end of the row, thereby causing radio signals to be emitted by the antenna arrangement substantially along the transmission axis in a direction opposite to the first direction.

6. An antenna arrangement as claimed in claim 5, further comprising means for providing an excitation signal to each of the plurality of elements, such that, when the switch means are in the first configuration, the excitation signal is supplied in series from the element at the first end of the row towards the element at the opposite end of the row, and when the switch means are in the second configuration, the excitation signal is supplied in series from the element at the opposite end of the row towards the element at the first end of the row.

7. An antenna arrangement as claimed in claim 5, wherein, in either the first or the second configuration, the lengths of the active portion of the elements increase substantially linearly from one end of the row towards the other end of the row.

8. A communication device for use in an ultra wideband network, the device comprising an antenna arrangement as claimed in claim 1.

9. An antenna arrangement substantially as hereinbefore described, with reference to, and as shown in, FIGS. 3 and 4 of the accompanying drawings.
